(19) United States
(12) Patent Application Publication
(10) Pub. No.: US 2018/0171665 A1
(43) Pub. Date: Jun. 21, 2018

(54) ANTI-TAMPERING RE-USABLE SEAL DEVICE

(71) Applicants: Maarten A. Anderson, Haarlem (NL); Jay Steinmetz, Baltimore, MD (US)

(72) Inventors: Maarten A. Anderson, Haarlem (NL); Jay Steinmetz, Baltimore, MD (US)

(21) Appl. No.: 15/835,729

(22) Filed: Dec. 8, 2017

Related U.S. Application Data
(60) Provisional application No. 62/436,204, filed on Dec. 19, 2016.

(51) Int. Cl. E05B 45/00; G07C 9/00

(52) U.S. Cl. CPC E05B 45/005; G07C 9/00182; E05B 2045/067; G07C 9/00944; G07C 9/00896

(57) ABSTRACT

Disclosed are devices, systems, apparatus, methods, products, and other implementations, including a seal device that includes a housing and a controller disposed inside the housing, with the controller including at least one sensor configured to measure motion data to detect motion of the seal device, and a communication module. The seal device further includes a seal connectable to the housing, with the seal including a shell and a conductive wire connectable to the controller. The controller is configured to cause the communication module to transmit at least one signal at least in response to one of, for example: a) determination, based on the motion data measured by the at least one sensor, of movement of the seal device, and/or b) detection of structural damage to the seal.

### CROSS-REFERENCE TO RELATED APPLICATIONS

This application claims priority to U.S. Application Ser. No. 62/436,204, filed on Dec. 19, 2016, which is incorporated herein by reference.

### BACKGROUND

To increase security of assets, and monitor use and access to such assets, seal devices may be used. A seal device may be secured to an asset in such a way that in order to access or otherwise use the asset, the seal of the seal device would need to be removed or broken. For example, the seal may be placed around a lock, latch, or handle of the asset to be protected, in such a way that the seal would inhibit opening or accessing the asset, and would thus need to be removed or broken in order to access the asset.

### SUMMARY

The devices, methods, products, systems, apparatus, and other implementations described herein include a seal device comprising a housing and a controller disposed inside the housing, with the controller including at least one sensor configured to measure motion data to detect motion of the seal device, and a communication module. The seal device further includes a seal connectable to the housing, with the seal including a shell and a conductive wire connectable to the controller. The controller is configured to cause the communication module to transmit at least one signal at least in response to one of, for example: a) determination, based on the motion data measured by the at least one sensor, of movement of the seal device, and/or b) detection of structural damage to the seal.

Embodiments of the seal device may include at least some of the features described in the present disclosure, including one or more of the following features.

The at least one sensor may include at least one of, for example, an accelerometer, a gyroscope, a magnetometer, a barometer, a thermometer, an optical sensor, and/or an RF receiver.

The controller may be configured to determine structural integrity of the seal. The controller configured to determine the structural integrity of the seal may be configured to determine disruption of electrical current flowing in the conductive wire of the seal, with the electrical current generated using one or more batteries disposed inside the housing of the seal device.

The controller configured to cause the communication module to transmit the at least one signal may be configured to cause the communication module to transmit at least one Bluetooth-based signal, with the at least one Bluetooth signal being receivable by one or more Bluetooth-based remote receiving devices.

The at least one signal may include one or more of, for example, identifier data representative of identity of the seal device, and/or alert data representative of detected status of the seal device.

The controller configured to cause the communication module to transmit the at least one signal may be configured to cause the communication module to transmit periodical signals receivable by one or more remote receiving devices, and cause the communication module to terminate transmission of the periodical signals in response to receipt, from a remote server, of a termination signal authorizing termination of the periodical signals, with the remote server being in communication with at least one of the one or more remote receiving devices configured to receive the periodical signals transmitted by the seal device.

The seal device may further include a mechanical latch to secure the seal to the housing of the seal device, with the latch configured to allow the seal to be removed from the housing.

The seal device may further include a magnetic attachment mechanism disposed inside the housing, with the magnetic attachment mechanism configured to magnetically attach the seal to the housing.

The housing may further include an inductive or capacitive shell configured to detect physical contact between an object and the shell.

In some variations, a method is provided that includes receiving motion data for a seal device comprising a housing, a controller disposed inside the housing, and a seal connectable to the housing, with the seal including a shell and a conductive wire connectable to the controller. The method further includes determining structural integrity of the seal connectable to the housing, and transmitting at least one signal at least in response to one of, for example: a) determination, based on the motion data received for the seal device, of movement of the seal device, and/or b) detection, based on the determined structural integrity of the seal, of structural damage to the seal device.

Embodiments of the method may include at least some of the features described in the present disclosure, including at least some of the features described above in relation to the seal device, as well as one or more of the following features.

Receiving the motion data may include measuring motion data using at least one sensor coupled to the seal device, with the at least one sensor including comprising at least one of, for example, an accelerometer, a gyroscope, a magnetometer, a barometer, a thermometer, an optical sensor, and/or an RF receiver.

Determining the structural integrity of the seal may include determining disruption of electrical current flowing in the conductive wire of the seal.

Transmitting the at least one signal may include transmitting at least one Bluetooth-based signal, with the at least one Bluetooth signal receivable by one or more Bluetooth-based remote receiving devices.

Transmitting the at least one signal may include transmitting periodical signals receivable by one or more remote receiving devices until receipt, from a remote server, of a termination signal authorizing termination of the transmitting of the periodical signals, with the remote server being in communication with at least one of the one or more remote receiving devices configured to receive the periodical signals transmitted by the seal device.

In some variations, a system is provided that includes a seal device comprising a housing, a controller disposed inside the housing, and a seal connectable to the housing, with the seal including a shell and a conductive wire connectable to the controller. The controller includes at least one sensor configured to measure motion data to detect motion of the seal device, and a communication module. The controller is configured to cause the communication module to transmit periodic wireless signals at least in response to one of, for example: a) determination, based on the motion data measured by the at least one sensor, of movement of the seal device, and/or b) detection of structural damage to the seal. The system further includes one or more remote wireless nodes, with one of the one or more remote wireless nodes configured to transmit a termination signal, in response to receipt of at least one of the periodical wireless signals by at least one of the one or more remote wireless nodes, to terminate transmission of the at periodic wireless signals by the seal device.

Embodiments of the system may include at least some of the features described in the present disclosure, including at least some of the features described above in relation to the seal device and the method, as well as one or more of the following features.

The controller is configured to determine structural integrity of the seal based on a determination of disruption of electrical current flowing in the conductive wire of the seal, with the electrical current generated using one or more batteries disposed inside the housing of the seal device.

The controller is further configured to cause the communication module of the seal device to terminate transmission of the periodical wireless signals in response to receipt, from the one of the one or more wireless nodes, of the termination signal.

Details of one or more implementations are set forth in the accompanying drawings and in the description below. Further features, aspects, and advantages will become apparent from the description, the drawings, and the claims.

### BRIEF DESCRIPTION OF THE DRAWINGS

These and other aspects will now be described in detail with reference to the following drawings.

FIG. 1 is an exploded view diagram of an example seal device.

FIGS. 2A-H are various views of the seal device of FIG. 1.

FIG. 3 is a schematic diagram of an example device which may be used to implement a seal device controller and/or controller-based devices used to communicate with the seal device of FIG. 1.

FIG. 4 is a diagram of an example system that includes a seal device in communication with one or more remote nodes.

FIG. 5 is a flowchart of an example procedure to monitor activities of a seal device.

FIG. 6 is a schematic diagram of a processor-based device that may be used to implement, at least partly, some of various devices and nodes depicted in FIGS. 1-4.

Like reference symbols in the various drawings indicate like elements.

### DETAILED DESCRIPTION

An anti-tamper re-usable seal device, to enhance security of assets to be protected (in order to inhibit attempts to break into the asset, or to remove the asset), is disclosed. In some embodiments, the seal device includes a housing, a controller disposed inside the housing, with the controller including at least one sensor (e.g., at least one RF transceiver, at least one inertial sensor, etc.) configured to collect/measure data to detect motion of the seal device, and a communication module. The seal device further includes a seal connectable to the housing, with the seal including a shell and a conductive wire connectable to the controller.

The controller is configured to cause the communication module to transmit at least one signal at least in response to one of, for example: a) determination, based on motion data measured by the at least one sensor, of movement of the seal device, and/or b) detection of structural damage to the seal. In some embodiments, the controller may be configured to determine structural damage to seal by determining the structural integrity of the seal (connectable to the housing). For example, the controller may determine the structural integrity of the seal by determining if there has been a disruption of electrical current (generated using batteries disposed in the housing of the seal device) flowing in the conductive wire of the seal. In some embodiments, the controller configured to cause the communication module to transmit the at least one signal is configured to cause the communication module to transmit at least one Bluetooth-based signal, with the at least one Bluetooth signal receivable by one or more Bluetooth-based remote receiving devices. Thus, in such embodiments, the communication module of the seal device may broadcast a Bluetooth-based signal (e.g., an iBeacon signal configured according to a Bleutooth Low Energy protocol) that may be detected by any remote device configured to receive and detect such communication (such remote devices do not need to have been a priori paired with the seal device sending the broadcast beacons), and upon detection of the beacon signal, they may send a message to a central device (server) with information corresponding to the data transmitted by the seal device (e.g., data indicative of the identity of the seal device and/or of the event that prompted the transmission of the signals).

As will be discussed in greater detail below, in some embodiments, the controller configured to cause the communication module to transmit the at least one signal may be configured to cause the communication module to transmit periodical signals receivable by one or more remote receiving devices, and cause the communication module to terminate transmission of the periodical signals in response to receipt, from a remote server, of a termination signal authorizing termination of the periodical signals, with the remote server being in communication with at least one of the one or more remote receiving devices configured to receive the periodical signals transmitted by the seal device. Thus, in such embodiments, upon the seal device detecting an event that causes it to transmit signals (e.g., the seal device has been moved, or the seal is cut), the communication module of the seal device will commence and continue to broadcast periodical signals (e.g., an alert or distress signal) until the seal device receives an authorization signal to cause the broadcast signals to cease/terminate (e.g., an authorization signal confirming that movement of the seal device is authorized).

Further embodiments of the devices, systems, methods, and other implementations described herein include a method comprising receiving motion data from at least one sensor coupled to a seal device, with the seal device comprising a housing, a controller disposed inside the housing, and a seal connectable to the housing, with the seal including a shell and a conductive wire connectable to the controller. The method further includes determining structural integrity of the seal connectable to the housing, and transmitting at least one signal at least in response to one of, for example: a) determination, based on the motion data received from the at least one motion sensor, of movement of the seal device, and/or b) detection, based on the determined structural integrity of the seal, of structural damage to the seal device.

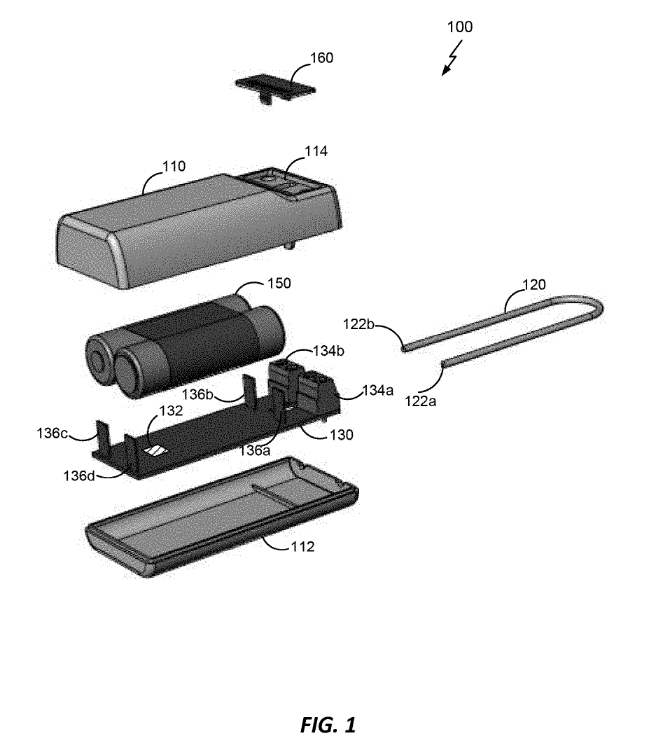

Thus, with reference to FIG. 1, an exploded view diagram of a seal device 100, configured to communicate with remote devices in order to provide alerts of a possible attempt to tamper with the seal device, is shown. The seal device 100 includes a first housing portion 110 which is couplable to a second housing portion 112. When the first housing portion 110 is attached to the second housing portion (e.g., through mechanical means, such as pins, tabs, or other projections provided on one portion, fitted into complementary slots or openings on the other housing portion), the two portions define a housing with an interior space in which a base board 130 (also referred to as a support structure) is disposed. In some embodiments, the base board 130 may be a printed circuit board (PCB). The base board 130 is configured to be provide mechanical and/or electrical connections to various mechanical and/or electrical components of the seal device (e.g., the base board may include terminals into which components may be securely fitted, and allow electrical connections thereto).

As illustrated in FIG. 1, coupled to the base board 130 are, for example, four electrical battery terminals 136a-d connectable to one or more batteries 150, which define a power source to power the electrical components (performing the functionality of the seal device, as described herein). For example, the batteries (or some other type of power source) provide the power required to monitor/detect tampering attempts with the seal device, and transmit communication signals to remote devices upon detection of possible tampering events. Although two batteries 150 are depicted in FIG. 1, any number of batteries may be provided for placement within the interior of the housing. Furthermore, other types of power sources (e.g., power harvesting modules, such as photovoltaic cells) may be disposed in the interior volume of the housing, or on the exterior of the housing.

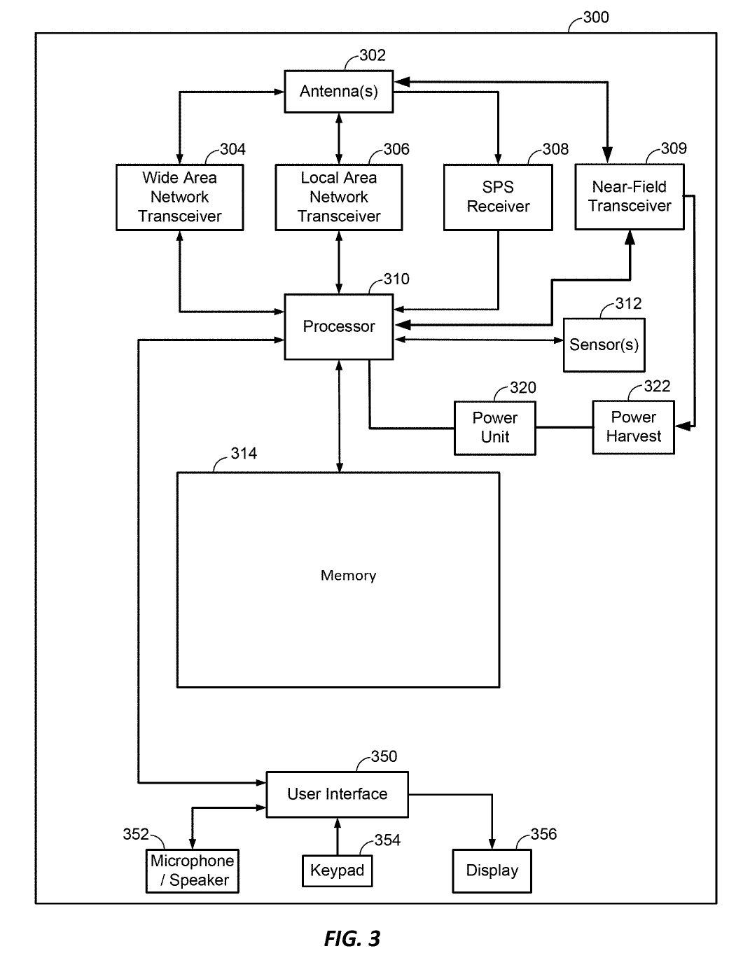

As depicted in FIG. 1, further disposed on the base board 130 is a controller 132, which may be realized as an integrated circuit (chip) that includes, inter alia, a processor to process data (measured or otherwise obtained) and generate control signals to control the operations of various units of the controller 132 and/or other electrical components of the seal device 100. In addition to a processor, the controller 132 may also include at least one sensor (e.g., an inertial sensor, such as an accelerometer or a gyroscope) configured to measure motion data used to detect motion of the seal device, and a communication module comprising one or more transceivers, such as a WLAN transceiver, a WWAN transceiver, a near-range transceiver (e.g., Bluetooth transceiver or Bluetooth-Low-Energy transceiver, or a transceiver configured to communicate according some other near-range (e.g., near-field) communication protocols), configured to transmit signals to one or more remote devices. The communication module may also be used to receive RF signals, based on which motion of the seal device may be determined. Further details regarding implementation of the controller are provided in relation to FIG. 3.

As further illustrated in FIG. 1, also disposed on the base board 130 are two seal terminals/projections 134a-b configured to receive the two ends 122a-b of a seal 120. The two ends 122a-b of the seal 120 may be mechanically received within two holes/openings defined in the seal terminals 134a-b (those two holes/openings are not illustrated in FIG. 1). In some embodiments, the seal 120 may include a shell constructed out of electrically insulating material (e.g., various types of plastics, such as polyethylene) surrounding a conductive wire. When fitted within the holes/openings/ports of the seal terminals 134a-b, the conductive wire establishes an electrical connection with electrical contacts (not shown) within the seal terminals. When the ends of the conductive wire of the seal 120 are electrically connected to the electrical contacts within the seal terminals 134a-b, and the batteries 150 are placed inside the housing, a closed electrical circuit is established through the batteries terminals 136a-d, the seal terminals 134a-b and the ends of the conductive wire of the seal, resulting in the flow of electrical current within the conductive wire of the seal 120. If a rogue party attempts to tamper with the seal (in order to access an asset to which the seal device is attached), the flow of electrical current will be disrupted, thus resulting in the transmission of one or more wireless messages to alert of the possible tampering attempt.

In some embodiments, the seal 120 may be secured to the seal device using a latch 160 that locks the seal to the housing of the seal device. The latch 160 may be a replaceable/disposable mechanical latch (e.g., constructed from plastic) that can be unlatched (from receiving slots 114 defined in the first housing portion 110 of the housing of the seal device) by snapping/prying it out from the receiving slots by application of force (the latch may thus effectively serve as another seal, supplementary of the seal 120). The prying of the latch 160 may cause the latch to break, thus requiring a new latch (which typically would be available to authorized users of the seal device 110) to be installed in order to lock the seal into the seal device. On the other hand, when an unauthorized party breaks the latch in order to release the seal from its connection to the holes/openings in the seal terminals 134a-b, that unauthorized party will generally not have appropriate replacement latches, and, therefore, once the latch is removed, this may cause the seal device to generate and transmit wireless message(s) indicating a possible tampering attempt. An authorized party that removes the latch for legitimate reasons will typically have a replacement latch that, upon insertion into the receiving slots 114, will cause transmission of wireless messages to cease (alternatively, an authorized user may be able to disable transmission of wireless alerts). In some embodiments, the latch 160 may be removed using a key or instrument that is available to the authorized party, and, in such situations, the removed latch can be re-used to re-lock the seal to the seal terminals 134a-b of the seal device 100. In some embodiments, use of a proper key or instrument to remove the latch may cause the controller to detect a legitimate attempt to unlock the seal, thus avoiding the transmissions of wireless messages to alert of a possible tampering attempt.

In some embodiments, the seal 120 may be secured to the housing of the seal device 100 electro-magnetically. For example, a magnetic attachment mechanism (e.g., disposed within the seal terminals 134a-b) may be included with the seal device 100. In some embodiments, the magnetic attachment mechanism may be realized using an electromagnetic lock (e.g., based on an arrangement of an electromagnetic strip and an armature), or some other arrangement. In some embodiments, the magnetic attachment mechanism may be implemented in a fail-secure configuration, in which when electrical power is not delivered to the magnetic attachment mechanism, the magnetic attachment mechanism will be in a locked state (preventing or inhibiting the seal 120 from being removed). In such a configuration, electrical current would need to be delivered to the magnetic attachment mechanism to release the seal 120. Alternatively, in some embodiments, the magnetic attachment mechanism may be implemented in a fail-safe configuration, in which power delivery causes the magnetic attachment mechanism to be activated and thus to keep the seal locked into the housing. In such embodiments, termination of power delivery causes the magnetic attachment mechanism to de-activate, and the seal 120 to be unlocked.

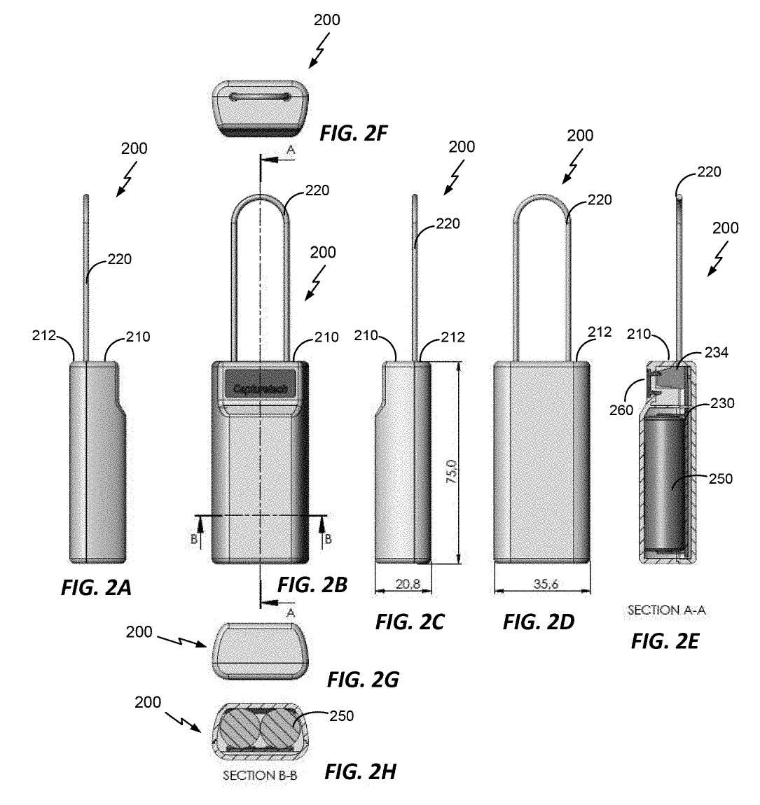

FIGS. 2A-H provide various views of a seal device 200, which may be similar to the seal device 100 of FIG. 1, when assembled (i.e., with the housing portions attached to each other, and the seal, similar to the seal 120 of FIG. 1, inserted into the seal terminals within the housing). More particularly, FIG. 2A is a side view of the seal device 200 showing a seal 220 inserted into a housing comprising a first housing portion 210 and a second housing portion 212. FIG. 2C is another side view of the seal device 220, showing a side of the seal device 200 opposite the side shown in FIG. 2A. FIG. 2B is a front view of the device 200 showing the first (front) housing portion 210, and the seal 220 inserted into the housing defined by the first housing portion 210 and the second housing portion 212 (also shown in FIG. 2D, which is a front view of the seal device 200, looking to the second (back) housing portion 212). FIGS. 2C and 2D also provide example possible dimensions (in millimeters) of the seal device 200. Also provided are FIG. 2F, which is a top view of the seal device 200, FIG. 2G, which is a bottom view of the seal device 200, and FIG. 2H, which is a cross-sectional view of the housing of the seal device 200 along the lines B-B depicted in FIG. 2B.

FIG. 2E is a cross-sectional view of the seal device 200 taken along the line A-A depicted in FIG. 2B, and showing the interior of the housing (defined by the first and second housing portions 210 and 212, respectively). As illustrated, one arm of the U-shaped seal 220 is received in a hole/opening/port of a seal terminal 234 (which may similar to either one of the seal terminals 134a or 134b of FIG. 1). A latch 260, which may be similar to the latch 160 of FIG. 1 is received within the seal terminal 234 to lock the seal 220 into the terminal 234. When the seal 220 is locked into the housing of the seal device (e.g., by operation of the latch 260, or otherwise), and a battery 250 (which may be similar to the batteries 150 of FIG. 1) is provided, a closed circuit is formed through the conductive wire of the seal 220, the electrical contacts of the terminal 234, and the battery terminals within the interior of the housing of the seal device, resulting in flow of current through the conductive wire of the seal 220. Disruption of the current (by cutting the seal 220, removing the latch 260 that locks the seal 220 to the housing, or removing the seal) will result in commencement of transmission of wireless messages, receivable by one or more remote devices configured to communicate with a communication module of the seal device 200 (similar to the communication module discussed with respect to FIGS. 1 and 3), to alert of a possible seal tampering event. As noted, the transmission of the alert wireless message(s) may be terminated by either restoring current flow (or otherwise mitigating/fixing the change to the structure of the seal device that caused the alert at the first place), or by receiving an authorization signal from a remote device (e.g., a central server) authorizing termination of the transmission of the wireless messages from the seal device and/or resumption of regular operation of the seal device.

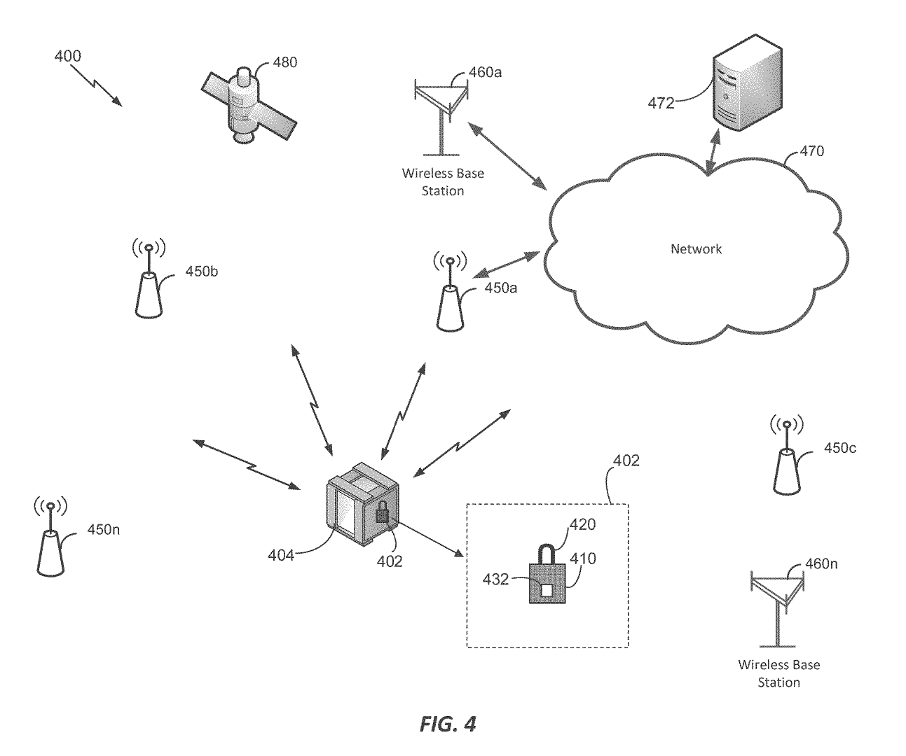

With reference now to FIG. 3, a schematic diagram of an example device 300, which may be similar to, and be configured to have a functionality similar to that, of the controller 132 used with the seal device 100 (or of the seal devices illustrated in FIG. 2), is shown. The example device 300 may also be used in the implementation of any of the devices depicted in FIG. 4. It is to be noted that one or more of the modules and/or functions illustrated in the example device of FIG. 3 may be further subdivided, or two or more of the modules or functions illustrated in FIG. 3 may be combined. Additionally, one or more of the modules or functions illustrated in FIG. 3 may be excluded.

As shown, the example device 300 may include a communication module comprising one or more transceivers (e.g., a LAN transceiver 306, a WLAN transceiver 304, a near-range transceiver 309, etc.) that may be connected to one or more antennas 302. The transceivers 304, and 306, and/or 309 may comprise suitable devices, hardware, and/or software for communicating with and/or detecting signals to/from a network or remote devices (such as devices/nodes depicted in FIG. 4). In some embodiments, the transceiver 306 may support wireless LAN communication (e.g., WLAN, such as WiFi-based communications) to thus cause the device 300 to be part of a WLAN implemented as an IEEE 802.11x network. In some embodiments, the transceiver 304 may support the device 300 to communicate with one or more cellular access points (also referred to as a base station) used in implementations of Wide Area Network Wireless Access Points (WAN-WAP), which may be used for wireless voice and/or data communication. A wireless wide area network (WWAN) may be part of a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards, and a TDMA network may implement Global System for Mobile Communications (GSM), Digital Advanced Mobile Phone System (D-AMPS), or some other RAT.

In some variations, the device 300 may also include a near-range transceiver (interface) 309 configured to allow the device 300 to communicate with in-range remote devices configured according to, for example, Bluetooth (classical Bluetooth) or Bluetooth Low Energy (BLE) protocol, or some other near-field communication protocol such as, for example, Ultra Wide Band, ZigBee, wireless USB, etc. As further illustrated in FIG. 3, in some embodiments, an SPS receiver 308 may also be included in the device 300. The SPS receiver 308 may be connected to the one or more antennas 302 to receive satellite signals. The SPS receiver 308 may comprise suitable hardware and/or software for receiving and processing SPS signals. The SPS receiver 308 may request information as appropriate from the other systems, and may perform the computations necessary to determine the device's 300 position using, in part, measurements obtained by any suitable SPS procedure. Such positioning information may be used, for example, to determine the location and motion of the seal device, based on which a determination of whether to broadcast an alert wireless message (e.g., to in-range remote devices operating according to BLE, or some other near-range communication protocol) may be made. Additionally and/or alternatively, the device 300 may derive positioning information based on signals communicated to and from communication nodes with which it is communication/interacting (including WLAN access points, WWAN base stations, near-range wireless nodes, etc.), e.g., by performing multilateration position determination procedures based on metrics derived from the communicated signals. Such metrics from which the device 300's position may be determined include, for example, timing measurements (using techniques based on round trip time, or RTT, measurements, observed-time-difference-of-arrival, or OTDOA, in which time differences in received signals from a plurality of network nodes are measured, and so on), signal-strength measurements (e.g., received signal strength indication, or RSSI, measurements, which provide a representation of signal power level of a signal received by an antenna of the receiving device), etc.

The device 300 may include one or more sensors 312 that may be housed within the same structure that houses a processor 310 of the device 300 (e.g., sensors that are placed on the same chip constituting a controller such as the controller 132) or may be positioned remotely from the structure housing the processor 310 (e.g., the sensors may be deployed at different locations within or on the outside of the housing of a seal device). The one or more sensors 312 communicate with the processor 310 through wired or wireless communication links. The one or more sensors 312 may include motion/orientation sensors (also referred to as inertial sensors) that measure and provide data that includes relative movement and/or orientation information which is independent of motion data derived from signals received by, for example, the transceivers 304, 306, and/or 309, and the SPS receiver 308. By way of example but not limitation, sensors 312 may utilize an accelerometer (e.g., a MEMS device), a gyroscope, a geomagnetic sensor (e.g., a compass), and/or any other type of sensor. Moreover, sensor 312 may include a plurality of different types of devices and combine their outputs in order to provide motion information. The one or more sensors 312 may further include an altimeter (e.g., a barometric pressure altimeter), a thermometer (e.g., a thermistor), an audio sensor (e.g., a microphone), a camera or some other type of optical sensors (e.g., a charge-couple device (CCD)-type camera, a CMOS-based image sensor, etc., which may produce still or moving images that may be displayed on a user interface device, and that may be further used to determine an ambient level of illumination and/or information related to colors and existence and levels of UV and/or infra-red illumination), and/or other types of sensors. In some embodiments, a touch sensor, which may be implemented on the exterior of the housing of the seal device, may be used to determine physical contact between some object and the seal device (e.g., a person touching the seal device). In some implementations, a touch sensor may be realizing by constructing at least a portion of the housing (e.g., the assembly constructed from the first housing portion 110 and the second housing portion 112 of FIG. 1) as a capacitive or inductive shell. The processor 310 of the device 300 could then be configured to monitor and determine changes to the inductive or capacitive value of the material, which may be indicative of physical contact with another object.

The output of the one or more sensors 312 may provide additional data about the environment in which any of the devices/nodes of FIG. 1 are located, and such data may be used to perform control and/or location determination operations in relation to the seal device. For example, temperature information may be determine environmental condition changes that may be indicative of possible movement of the seal device, or otherwise of an attempt to compromise the integrity of the seal device or of the asset(s) attached to it.

With continued reference to FIG. 3, the device 300 may include a power unit 320 such as one or more batteries (such as the batteries 150 depicted in FIG. 1) and/or a power conversion module that receives and regulates power from an outside source (e.g., AC power, in situations where the device 300 is used to implement a stationary device). In some embodiments, e.g., when the device 300 is used to implement a device which may not have readily available access to replacement power (e.g., replacement batteries) or AC power, the power source 320 may be connected to a power harvest unit 322. The power harvest unit 322 may be configured to receive RF communications, and harvest the energy of the received electromagnetic transmissions (although FIG. 3 illustrates the unit 322 receiving RF communication via the near-range interface 309, the power harvest unit 322 may be connected to, and receive RF energy from, any of the other communication interfaces depicted in FIG. 3). An RF harvest unit generally includes an RF transducer circuit to receive RF transmissions, coupled to an RF-to-DC conversion circuit (e.g., an RF-to-DC rectifier). Resultant DC current may be further conditioned (e.g., through further filtering and/or down-conversion operation to a lower voltage level), and provided to a storage device realized, for example, on the power unit 320 (e.g., capacitor(s), a battery, etc.)

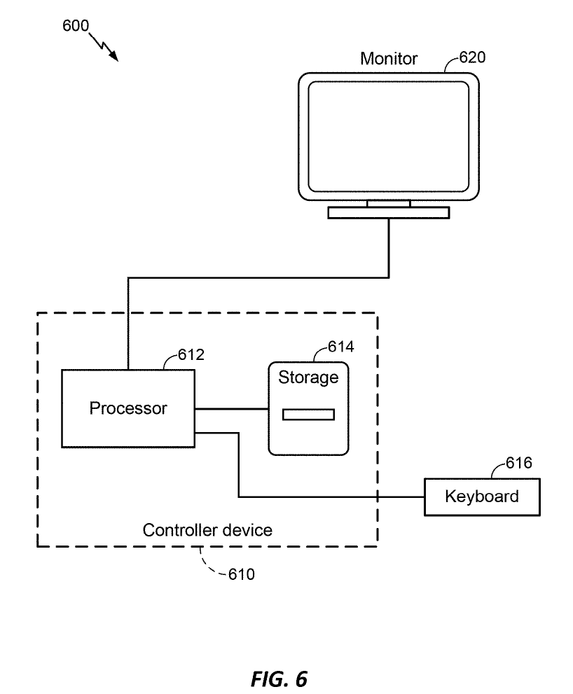

The processor 310 may be connected to the transceivers 304, 306, and/or 309, the SPS receiver 308 and the one or more sensors 312. The processor may include one or more microprocessors, microcontrollers, and/or digital signal processors that provide processing functions, as well as other computation and control functionality. The processor 310 may also include memory 314 for storing data and software instructions for executing programmed functionality within the device. For example, the device 300 may be configured to (via software modules/applications provided on the memory 314) to implement a process to monitor and detect the state of a seal device (to which the device 300 is coupled), including to determine motion of a seal device and/or the structural integrity of the seal device. For example, data from one or more of the sensors 312, and/or from one of the RF transceivers, may be processed to determine whether the seal device is moving, whether the seal device has been touched (e.g., based on changes to the inductive or capacitive values of at least a portion of the housing of the seal device), whether there has been a disruption to normal electrical flow provided through the conductive wire of the seal (e.g., the seal 120 of FIG. 1) which may have been caused if the conductive wire has been cut, or if the latch 160 was removed and as a result caused poor electrical contact between the wires and electrical terminals within the holes/ports provided in seal terminals (such as the seal terminals 134a-b of FIG. 1), etc. The processes implemented, at least in part, based on programmable instructions stored in the memory 314, may also include a process to cause one or more of the transceivers of the device 300 to transmit wireless messages (e.g., broadcast messages, such as iBeacon BLE messages) that may be received by one or more remote device (configured to receive such wireless communication) in response to a determination of the existence of an event, at a seal device, requiring the transmission of the wireless message. For example, the movement of the seal device, or disruption of electrical current flowing through the seal may indicate a possible tampering attempt (theft or break-in attempt into the asset attached to the seal device). The wireless message sent by one or more of the transceivers could then be received by one or more of the remote device, and relayed to a central server configured to monitor the state of the seal device. If the event that trigger the transmission of the wireless message(s) by the device 300 is a legitimate event (e.g., an authorized movement of the seal device and/or asset, or an authorized seal removal), a central server (which may also be implemented based on the device 300) would be configured to implement a process to transmit an authorization signal to cause transmission of wireless messages from the seal device to cease. The memory 314 may be on-board the processor 310 (e.g., within the same IC package), and/or the memory may be external memory to the processor and coupled thereto over a data bus. Further details regarding an example embodiments of a processor or computation system, which may be similar to that of the processor 310, are provided below in relation to FIG. 6.

The example device 300 may further include a user interface 350 which provides any suitable interface systems, such as a microphone/speaker 352, keypad 354, and display 356 that allows user interaction with the device 300. As noted, such a user interface, be it an audiovisual interface (e.g., a display and speakers), or some other type of interface (visual-only, audio-only, tactile, etc.), configured to provide status data, alert data, and so on, to a user using the device 300. The microphone/speaker 352 provides for voice communication functionality, and may also include or be coupled to a speech synthesizer (e.g., a text-to-speech module) that can convert text data to audio speech so that the user can receive audio notifications. Such a speech synthesizer may be a separate module, or may be integrally coupled to the microphone/speaker 352 or to the processor 310 of the device of FIG. 3. The keypad 354 includes suitable buttons for user input, e.g., which may be used to enter a key to unseal or lock the seal of a seal device implementation, or to enter a unique ID that can be included with transmissions sent by a seal device implementation to identify the seal device implementation in response to detection of motion of the seal device or a tampering attempt. The display 356 includes any suitable display, such as, for example, a backlit LCD display, and may further include a touch screen display for additional user input modes. In some embodiments, the display 356 may be a bi-state display that may be powered through power received through the power harvest unit 322, with the bi-state display being configured to maintain (i.e., without requiring on-going supply of energy) the display of particular data (e.g., characters and/or graphics) until the state (i.e., the data) for the bi-state display is changed/updated again. Further details regarding use of a bi-state display for some implementations of the device 300 are provided, for example, in U.S. Pat. No. 8,616,457, entitled “RFID display label for battery packs,” the content of which is incorporated herein by reference in its entirety.

With reference to FIG. 4, an example system 400 that includes a seal device 402 (which may be similar to the seal devices 100 and 200 depicted in FIGS. 1 and 2) to transmit wireless alert/distress messages receivable by one or more remote devices is shown. The system 400 includes at least the seal device 402, attached to an asset 404 to be protected (e.g., a crate or a box, in the example of FIG. 4), with the seal device 402 including a controller 432 (which may be similar to the controller 132 of FIG. 1, or the device 300 of FIG. 3). Although one seal device is depicted in FIG. 4, any number of such seal devices may be used. The seal device 402 includes a housing 410, which may be structured in a manner similar to that shown in FIG. 1 or 2 (e.g., as an assembly of a first housing portion and a second housing portion), that encloses a base board (such as the base board 130 of FIG. 1, which may be a PCB) on which the controller 432 may be disposed. The controller 432 may include at least one sensor (e.g., accelerometer, gyroscope, magnetometer, barometer, one or more RF transceivers, etc.) configured to detect motion of the seal device, and a communication module (which may include the one or more transceivers, such as any of the transceivers 304, 306, 309 of FIG. 3) configured to receive and/or transmit wireless communications according to WLAN communication protocols, near-range communication protocols (Bluetooth, Bluetooth Low Energy, RFID, etc.), WWAN communication protocols, etc. An example implementation of a near-range interface that may be used, in some embodiments, is a Bluetooth Low Energy (BLE) communication interface, which is suited for implementation in which power (e.g., electrical power) may be limited or scarce. The communication module is configured to transmit and receive transmissions (also referred to as beacons) that may have been configured according to, for example, an iBeacon protocol (when the communication module is implemented according to the BLE protocol). Where the communication module (interface) is realized using different communication protocols/technologies, different types of transmissions may be used.

As further illustrated in FIG. 4, the seal device 402 further include a seal 420 (depicted as a ‘U’-shaped member) that can be released mechanically (e.g., using a latch mechanism, such as the latch 160 of FIG. 1, with such a latch being a re-usable or a one-time disposable latch) or electrically (e.g., using a magnetic attachment mechanism to secure the seal into the housing). In some embodiments, when the seal 420 is released or broken (e.g., as may be indicated when normal electrical current flow in a conductive wire passing through the seal has changed; for example, removal of the mechanical latch would create a loose connection between the wire and electrical terminal resulting in a jittery current flow), the controller 432 may cause the communication module to transmit one or more wireless messages (e.g., BLE iBeacon advertisements, or transmissions according to some other protocol) that are receivable by one or more receiving remote devices, such as any of wireless nodes 450a-n, the base stations 460a-n, or any other type of wireless node (including personal mobile devices configured to receive, and act upon, the wireless signals/communications sent by the seal device 402).

Any of the depicted devices and nodes of the system 400 may be elements in various types of communications networks, including a wide area wireless network (WWAN), a wireless local area network (WLAN), a wireless personal area network (WPAN), and so on. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. A WLAN may include, for example, an IEEE 802.11x network. A WPAN may include, for example, a Bluetooth network (including one based on Bluetooth Low Energy protocol), an IEEE 802.15x, RDID-based networks, other near-range communication networks, etc. In some embodiments, 4G networks, Long Term Evolution (“LTE”) networks, Advanced LTE networks, Ultra Mobile Broadband (UMB) networks, and all other types of cellular and/or wireless communications networks may also be implemented and used with the systems, methods, and other implementations described herein. While the example illustrated in FIG. 4 includes two wireless base station and four shorter-range wireless nodes (which may be WLAN nodes), in other implementations the network environment or system illustrated in FIG. 4 may include more or fewer than the nodes 450a-n and/or 460a-n shown, and may have coverage areas that may overlap (at least in part).

The wireless signals/messages transmitted by the communication module of the seal device 402 may be in response to events such as detected motion of the seal device (determined based on measurements performed by one or more sensors included with the seal device, or based on changes to positioning of the seal device derived based on RF signals received by the seal device from remote wireless nodes or from one or more satellite vehicles such as a satellite 480 illustrated in FIG. 4), or in response to some other event (touching of the housing of the seal device by a foreign object, detection of structural change (e.g., disruption of electrical current) to the seal device, etc.) In some embodiments, the wireless communications/signals sent by the communication module of the seal device 402 may include data such as an identifier data representative of an identity of the seal device (e.g., a unique ID assigned to the seal device), and alert data representative of detected status of the seal device (e.g., the type of event detected by the controller; for example, whether motion of the seal device has been detected, disruption of current flow in the conductive wire of the seal, and/or other types of events).

At least one of the remote devices that receive a wireless signal/message sent by the seal device 402 may be configure to relay the message, or send a different message (using the same or different communication protocol), to a central server, such as a server 472 depicted in FIG. 4, via a network 470. The receiving remote device(s) may be configured to respond to any received communication, from any seal device, upon detection of the received signals (i.e., in some embodiments, the receiving wireless device do not necessarily need to be paired with any of seal devices). In some embodiments, one of the receiving remote wireless devices may also serve as the central server monitoring the status of seal device 402 and/or other seal devices. The server 472 may be configured to establish communication links with one or more of the nodes or devices of the system 400 (e.g., with the seal device 402, other seal devices not shown in FIG. 4, the nodes 450a-n, the base stations 460a-n, or any other wireless device), all of which may be part of the network 470. The central server 472 may be configured to communicate data and/or control signals to those nodes, and receive data and/or control signals from the nodes.

In some embodiments, the central server 472 may be configured to determine if the transmission of wireless signals by the seal device 402 was in response to occurrence of an unauthorized event (e.g., unauthorized or unexpected movement of the seal device), or if the transmission of such a wireless signal/message was expected or otherwise authorized. Thus, in such embodiments, the server 472 may maintain an activity log or schedule indicative of authorized/expected future events that are supposed to occur with respect to the seal device 402 (and other devices monitored/tracked by the server) and/or with respect to the assets associated with the seal device(s). For example, the server may, independently of messages transmitted by the seal device 402, receive data representative of expected movement of the seal device or associated assets, or expected activities of the seal device (e.g., release/opening, and locking events for the seal device). Upon receiving a wireless message indicative of an event from the seal device, the central server can determine if the event reported in the message (corresponding the event or alert data provided in the message, and the identification data for the seal device that initiated the transmission of the wireless message(s)) corresponds to expected event data for that seal device. If it does, i.e., data received in the wireless message indicates movement of the seal device, and log data maintained by the server indicates that there was planned or expected movement of the seal device, the server may transmit to the seal device (directly, or via one or more intermediary wireless nodes) an authorization message to cause the seal device 402 (upon receipt of the authorization message from the central server) to cease transmission of alert messages. In some embodiments, the server may confirm that the alert message sent by the seal device by independently receiving, from a trusted source (e.g., an authorized user) another message to confirm that the event reported by the alert wireless message(s) sent by the seal device corresponds to a legitimate event (that confirmatory other message may be sent, by the trusted source, substantially concomitantly with the occurrence of the event causing the transmission of the wireless message/signals by the seal device). If the central server cannot determine whether the alert message corresponds to a legitimate event, the server may deem the receipt of alert message as indicating a possible unauthorized activity, and may cause some mitigating action to take place (e.g., report the occurrence of the possible unauthorized activity for further investigation). In some embodiments, messages sent by the seal device 402, intermediary devices (such as the nodes 450a-n and 460a-n), and/or the central server 472, may include cryptographic signatures (e.g., generated using secret keys associated with transmitting devices) in order to verify the authenticity of the transmitted messages (e.g., as arriving from legitimate sources).

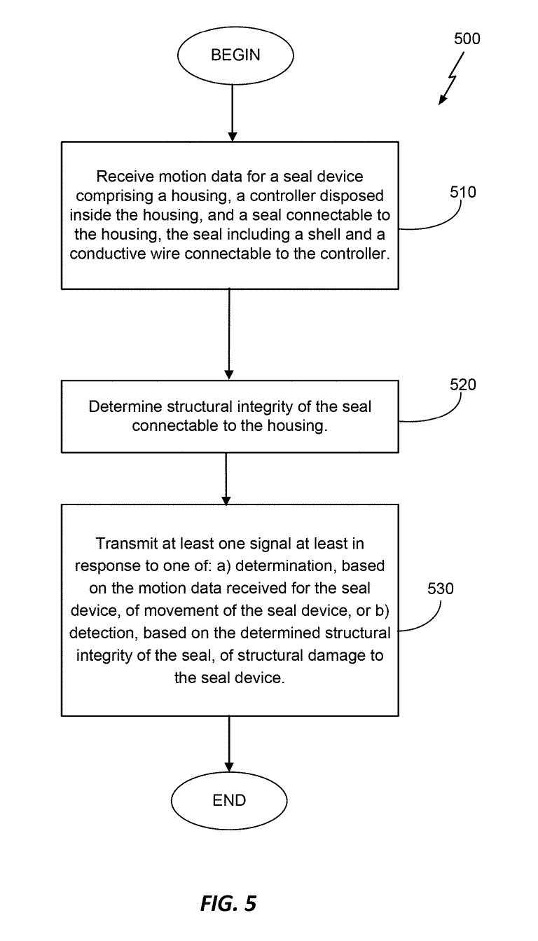

With reference now to FIG. 5, a flowchart of an example procedure 500 to monitor activities of a seal device (such as the seals device 100, 200, 300, and 402 of FIGS. 1, 2, 3, 4, respectively) is shown. The procedure 500 includes receiving 510 motion data for a seal device comprising a housing, a controller (e.g., such as the controller 132 or the device 300 shown in FIGS. 1 and 3, respectively) disposed inside the housing, and a seal (such as the seal 120 of FIG. 1), connectable to the housing, that includes a shell and a conductive wire connectable to the controller. As noted, receiving the motion data may include receiving positioning signals received from wireless nodes (e.g., the nodes 450a-n and 460a-n of FIG. 4, the satellite vehicle 480 of FIG. 4, etc.), and/or receiving motion sensor measurements by at least one motion sensor of the seal device (e.g., an accelerometer or a gyroscope). The procedure 500 further includes determining 520 structural integrity of the seal connectable to the housing. In some embodiments, determining the structural integrity of the seal may include determining disruption of electrical current flowing in the conductive wire of the seal. For example, electrical current flows in the wire of the seal when the seal is secured/locked into the housing (e.g., into ports/openings defined in seal terminals such as seal terminals 134a-b of FIG. 1). Locking of the seal into the housing can be achieved by mechanical force (applied by a mechanical latch such as the latch 160 of FIG. 1) or by electro-magnetic actuation (when a magnetic attachment mechanism is used). If the latch is removed or broken or if the magnetic attachment mechanism is disabled (either of which may cause a more tenuous connection between the conductive wire of the seal and electrical contacts inside the seal terminals), or if the wire is cut, electrical current that normally flows in the wire when the seal is intact and operating will be disrupted, thus indicating that the structural integrity of the seal may have been compromised, and that a possible breach of the seal device has occurred.

With continued reference to FIG. 5, the procedure 500 further includes transmitting 530 at least one signal at least in response to one of: a) determination, based on the motion data, of movement of the seal device, or b) detection, based on the determined structural integrity of the seal, of structural damage to the seal device. In some embodiments, transmission of the at least one signal (corresponding to an alert or distress message) may occur in response to detection of other types of events.

In some embodiments, transmitting the at least one signal may include transmitting periodical signals receivable by one or more remote receiving devices (e.g., like the nodes 450a-n or 460 a-n of FIG. 4) until receipt, from a remote server (e.g., such as the server 472 of FIG. 4), of a termination signal authorizing termination of the transmitting of the periodical signals, with the remote server being in communication with at least one of the one or more remote receiving devices configured to receive the periodical signals transmitted by the seal device. In some embodiments, an authorized user may disable the transmission of alert/distress message responsive to various events (i.e., the authorized user can disable transmission of distress signals to avoid sending the wireless messages even if certain events, e.g., motion of the seal device or structural damage to the seal device, have been detected).

In some embodiments, transmitting the at least one signal may include transmitting at least one Bluetooth-based signal, with the at least one Bluetooth signal receivable by one or more Bluetooth-based remote receiving devices. In some embodiments, the at least one signal may include identifier data representative of identity of the seal device, and/or alert data representative of detected status of the seal device (e.g., identifying the type of event that was detected by the seal device and caused it to commence transmission of alert signals/messages).

Performing the various operations described herein may be facilitated by a processor-based computing system. Particularly, each of the various systems/devices described herein (including the controller of the seal device, the controller of any of the wireless nodes in communication with the seal device, etc.) may be implemented, at least in part, using one or more processing-based devices such as a computing system. Thus, with reference to FIG. 6, a schematic diagram of a computing system 600 is shown. The computing system 600 includes a processor-based device 610 (also referred to as a controller device) such as a personal computer, a specialized computing device, and so forth, that typically includes a central processor unit 612. In addition to the CPU 612, the system includes main memory, cache memory and bus interface circuits (not shown). The processor-based device 610 may include a mass storage element 614, such as a hard drive or flash drive associated with the computer system. The computing system 600 may further include a keyboard, or keypad, or some other user input interface 616 (such as a keyboard), and a monitor 620, e.g., a CRT (cathode ray tube) or LCD (liquid crystal display) monitor, that may be placed where a user can access them.

The processor-based device 610 is configured to facilitate, for example, the implementation of operations to monitor activities/operations of a seal device (such as the seal device 100 of FIG. 1), transmit wireless signals/messages in response to detection of certain events, transmit (e.g., by a central server device) authorization signals to terminate periodical messages transmitted by the seal device, etc. The storage device 614 may thus include a computer program product that when executed on the processor-based device 610 causes the processor-based device to perform operations to facilitate the implementation of the above-described procedures and operations. The processor-based device may further include peripheral devices to allow input/output functionality. Such peripheral devices may include, for example, a CD-ROM drive and/or flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, etc., may be used in the implementation of the system 600. Other modules that may be included with the processor-based device 610 are speakers, a sound card, a pointing device, e.g., a mouse or a trackball, by which the user can provide input to the computing system 600. The processor-based device 610 may include an operating system, e.g., Windows XP® Microsoft Corporation operating system. Alternatively, other operating systems could be used.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A seal device comprising:
a housing;
a controller disposed inside the housing, the controller comprising:
at least one sensor configured to measure motion data to detect motion of the seal device, and
a communication module; and
a seal connectable to the housing, wherein the seal comprises a shell and a conductive wire connectable to the controller;
wherein the controller is configured to:
cause the communication module to transmit at least one signal at least in response to one of: a) determination, based on the motion data measured by the at least one sensor, of movement of the seal device, orb) detection of structural damage to the seal.

2. The seal device of claim 1, wherein the at least one sensor comprises at least one of: an accelerometer, a gyroscope, a magnetometer, a barometer, a thermometer, an optical sensor, or an RF receiver.

3. The seal device of claim 1, wherein the controller is configured to determine structural integrity of the seal.

4. The seal device of claim 3, wherein the controller configured to determine the structural integrity of the seal is configured to:
determine disruption of electrical current flowing in the conductive wire of the seal, the electrical current generated using one or more batteries disposed inside the housing of the seal device.

5. The seal device of claim 1, wherein the controller configured to cause the communication module to transmit the at least one signal is configured to:
cause the communication module to transmit at least one Bluetooth-based signal, the at least one Bluetooth signal receivable by one or more Bluetooth-based remote receiving devices.

6. The seal device of claim 1, wherein the at least one signal comprises one or more of: identifier data representative of identity of the seal device, or alert data representative of detected status of the seal device.

7. The seal device of claim 1, wherein the controller configured to cause the communication module to transmit the at least one signal is configured to:
cause the communication module to transmit periodical signals receivable by one or more remote receiving devices; and
cause the communication module to terminate transmission of the periodical signals in response to receipt, from a remote server, of a termination signal authorizing termination of the periodical signals, wherein the remote server is in communication with at least one of the one or more remote receiving devices configured to receive the periodical signals transmitted by the seal device.

8. The seal device of claim 1, further comprising a mechanical latch to secure the seal to the housing of the seal device, the latch configured to allow the seal to be removed from the housing.

9. The seal device of claim 1, further comprising a magnetic attachment mechanism disposed inside the housing, the magnetic attachment mechanism configured to magnetically attach the seal to the housing.

10. The seal device of claim 1, wherein the housing further comprises an inductive or capacitive shell configured to detect physical contact between an object and the shell.

11. A method comprising:
receiving motion data for a seal device comprising a housing, a controller disposed inside the housing, and a seal connectable to the housing, the seal including a shell and a conductive wire connectable to the controller;
determining structural integrity of the seal connectable to the housing; and
transmitting at least one signal at least in response to one of: a) determination, based on the motion data received for the seal device, of movement of the seal device, or b) detection, based on the determined structural integrity of the seal, of structural damage to the seal device.

12. The method of claim 11, wherein receiving the motion data comprises:
measuring motion data using at least one sensor coupled to the seal device, the at least one sensor comprising at least one of: an accelerometer, a gyroscope, a magnetometer, a barometer, a thermometer, an optical sensor, or an RF receiver.

13. The method of claim 11, wherein determining the structural integrity of the seal comprises:
determining disruption of electrical current flowing in the conductive wire of the seal.

14. The method of claim 11, wherein transmitting the at least one signal comprises:
transmitting at least one Bluetooth-based signal, the at least one Bluetooth signal receivable by one or more Bluetooth-based remote receiving devices.

15. The method of claim 11, wherein the at least one signal comprises one or more of: identifier data representative of identity of the seal device, or alert data representative of detected status of the seal device.

16. The method of claim 11, wherein transmitting the at least one signal comprises:
transmitting periodical signals receivable by one or more remote receiving devices until receipt, from a remote server, of a termination signal authorizing termination of the transmitting of the periodical signals, wherein the remote server is in communication with at least one of the one or more remote receiving devices configured to receive the periodical signals transmitted by the seal device.

17. A system comprising:
a seal device comprising a housing, a controller disposed inside the housing, and a seal connectable to the housing, with the seal including a shell and a conductive wire connectable to the controller, wherein the controller comprises at least one sensor configured to measure motion data to detect motion of the seal device, and a communication module, and wherein the controller is configured to cause the communication module to transmit periodic wireless signals at least in response to one of: a) determination, based on the motion data measured by the at least one sensor, of movement of the seal device, orb) detection of structural damage to the seal; and
one or more remote wireless nodes, with one of the one or more remote wireless nodes configured to transmit a termination signal, in response to receipt of at least one of the periodical wireless signals by at least one of the one or more remote wireless nodes, to terminate transmission of the at periodic wireless signals by the seal device.

18. The system of claim 17, wherein the at least one sensor comprises at least one of: an accelerometer, a gyroscope, a magnetometer, a barometer, a thermometer, an optical sensor, or an RF receiver.

19. The system of claim 17, wherein the controller is configured to determine structural integrity of the seal based on a determination of disruption of electrical current flowing in the conductive wire of the seal, the electrical current generated using one or more batteries disposed inside the housing of the seal device.

20. The system of claim 17, wherein the controller is further configured to:
cause the communication module of the seal device to terminate transmission of the periodical wireless signals in response to receipt, from the one of the one or more wireless nodes, of the termination signal.
